(19) United States
(12) Patent Application Publication
(10) Pub. No.: US 2013/0236364 A1
(43) Pub. Date: Sep. 12, 2013

(54) EXHAUST PURIFYING APPARATUS IN INTERNAL COMBUSTION ENGINE

(71) Applicants: Kenichi Tsujimoto, Mishima-shi (JP); Mikio Inoue, Susono-shi (JP)

(72) Inventors: Kenichi Tsujimoto, Mishima-shi (JP); Mikio Inoue, Susono-shi (JP)

(73) Assignee: TOYOTA JIDOSHA KABUSHIKI KAISHA, Toyota-shi, Aichi (JP)

(21) Appl. No.: 13/988,194

(22) PCT Filed: Nov. 19, 2010
(86) PCT No.: PCT/JP2010/006788

§ 371 Date: May 17, 2013

(51) Int. Cl. B01D 53/94

(52) U.S. Cl. CPC B01D 53/9495
USPC 422/109; 422/173; 422/119; 422/111

(57) ABSTRACT

The present invention provides an exhaust purifying apparatus in an internal combustion engine provided with an exhaust treatment device in an exhaust passage. The exhaust purifying apparatus comprises an oxidation device provided upstream of the exhaust treatment device, a fuel adding valve for adding fuel upstream of the oxidation device, and a glow plug provided upstream of the oxidation device for heating the fuel added from the fuel adding valve. The oxidation device is formed to be provided with gas passages the number of which is equal to or more than 30 and is equal to or less than 200 per 0.00064516 m² in an exhaust flow passage direction cross-section.

### TECHNICAL FIELD

The present invention relates to an exhaust purifying apparatus in an internal combustion engine provided with an exhaust treatment device having a function of purifying an exhaust gas.

### BACKGROUND ART

An exhaust treatment device having a function of purifying an exhaust gas is generally provided in an exhaust passage in an internal combustion engine. The exhaust treatment device can be provided with a catalyst and the like. Further, there are some cases where a fuel adding valve and a glow plug are provided upstream of the exhaust treatment device. In this case, fuel is added from the fuel adding valve, and heat can be given to the added fuel by the glow plug. The fuel adding valve and the glow plug can be utilized for heating the exhaust treatment device. In addition, in some cases an oxidation catalyst is further provided downstream of the glow plug and thereby oxidation of the fuel added by the fuel adding valve is accelerated.

Patent Literature 1 discloses an example of an exhaust purifying apparatus in an internal combustion engine. The exhaust purifying apparatus includes a compact oxidation catalyst having a small cross-sectional area, a fuel supply valve, and a glow plug arranged therebetween in an exhaust passage upstream of an exhaust treatment device. The fuel supply valve has an injection hole that is directed to an end surface of the compact oxidation catalyst, and the glow plug is arranged in a position where a tip end thereof makes contact with fuel that is injected from the fuel supply valve. Each operation of the fuel supply valve and the glow plug is controlled, and the fuel supply valve and the glow plug can be in first to third control conditions. In the first control condition, the fuel is supplied from the fuel supply valve, while the heating is performed by the glow plug, wherein the fuel from the fuel supply valve is ignited. In the second control condition, the fuel is supplied from the fuel supply valve, while the heating is performed by the glow plug, but the fuel from the fuel supply valve is not ignited. In the third control condition, the fuel is supplied from the fuel supply valve, while the heating by the glow plug is stopped. The first control condition or the third control condition can be selected in an operating region in which the ignition is possible, and the second control condition or the third control condition can be selected in an operating region in which the ignition is impossible.

### CITATION LIST

### Patent Literature

PTL 1: Japanese Patent Laid-Open No. 2010-059886

### SUMMARY OF INVENTION

### Technical Problem

As described above, in a case where the compact oxidation catalyst, that is, the oxidation device is provided upstream of the exhaust treatment device, the oxidation device generally includes a plurality of gas passages. However, an easy-to-pass degree of the gas in each of the gas passages differs depending on a configuration, a size and the like of each of the gas passages. For example, an easy-to-burn degree of the fuel added and supplied to the exhaust passage differs depending on the easy-to-pass degree of the gas. In a case where the gas is difficult to pass through, there are some cases where flames that are generated by the combustion of the added fuel go out in the oxidation device. This misfiring blocks the heating of the exhaust treatment device, and therefore, is not preferable.

Therefore an object of the present invention is to make an easy-to-pass degree of a gas in an oxidation device provided upstream of an exhaust treatment device preferable.

### Solution to Problem

According to an aspect of the present invention, there is provided an exhaust purifying apparatus in an internal combustion engine provided with an exhaust treatment device in an exhaust passage, comprising an oxidation device provided upstream of the exhaust treatment device, a fuel adding means for adding fuel upstream of the oxidation device, and a heating means provided upstream of the oxidation device for heating the fuel added from the fuel adding means, wherein the oxidation device is formed to be provided with gas passages the number of which is equal to or more than 30 and is equal to or less than 200 per 0.0006452 m² in an exhaust flow passage direction cross-section.

According to the aforementioned configuration, since the oxidation device is formed to be provided with the gas passages the number of which is equal to or more than 30 and is equal to or less than 200 per 0.0006452 m² in the exhaust flow passage direction cross-section, the gas can effectively pass through the oxidation device.

Preferably each of the gas passages in the oxidation device is formed such that a circle having a diameter which is equal to or more than 1.6 mm and is equal to or less than 4.9 mm makes internal contact therewith in the exhaust flow passage direction cross-section.

Preferably a detecting means output of which changes with a state of an exhaust gas downstream of the oxidation device and a determining means for determining the state of the exhaust gas downstream of the oxidation device based upon the output of the detecting means, are further provided. In this case, preferably a control means for controlling an operation of at least one of the fuel adding means and the heating means may control the operation of at least one of the fuel adding means and the heating means according to the state of the exhaust gas downstream of the oxidation device determined by the determining means.

Preferably a temperature detecting means provided in the exhaust passage downstream of the oxidation device, and a determining means for determining whether or not a temperature downstream of the oxidation device is less than a predetermined temperature corresponding to the passing of flames through the oxidation device, based upon output of the temperature detecting means, are further provided. In this case, preferably a control means for controlling an operation of at least one of the fuel adding means and the heating means may control the operation of at least one of the fuel adding means and the heating means in such a manner as to increase the heating amount more than before when it is determined that the temperature downstream of the oxidation device is less than the predetermined temperature by the determining means.

In addition, preferably an exhaust amount adjusting device for adjusting an exhaust amount that is supplied to the exhaust passage may further be provided. In this case, preferably the exhaust amount adjusting device, when it is determined that the temperature downstream of the oxidation device is less than the predetermined temperature by the determining means, may increase the exhaust amount more than before.

### Advantageous Effects of Invention

According to the present invention, there is realized an excellent effect that the easy-to-pass degree of the gas in the oxidation device provided upstream of the exhaust treatment device can be made preferable, thereby effectively adding the heat to the exhaust treatment device.

### BRIEF DESCRIPTION OF DRAWINGS

FIG. 1 is a schematic configuration diagram showing an internal combustion engine to which an exhaust purifying apparatus in the internal combustion engine according to an embodiment in the present invention is applied;

FIG. 2 is a partially enlarged cross-sectional schematic diagram of the exhaust purifying apparatus in FIG. 1;

FIG. 3 is a cross section diagram taken along lines III-III in FIG. 2;

FIG. 4 is a partial cross-sectional schematic diagram of an oxidation device in the exhaust purifying apparatus in FIG. 1;

FIG. 5 is a graph conceptually depicting a relation between the number of gas passages per unit cross-sectional area in the oxidation device, and a temperature downstream of the oxidation device;

FIG. 6 is a graph conceptually depicting a relation between the number of gas passages per unit cross-sectional area in the oxidation device, and a discharge amount of particulates;

FIG. 7 is a cross-sectional schematic diagram showing a gas passage in an alternative oxidation device, and is a diagram corresponding to FIG. 4;

FIG. 8 is a cross-sectional schematic diagram showing a gas passage in a different, alternative oxidation device, and is a diagram corresponding to FIG. 4;

FIG. 9 is a cross-sectional schematic diagram showing a gas passage in a further different alternative oxidation device, and is a diagram corresponding to FIG. 4; and

FIG. 10 is a flowchart for explaining an example of control in the exhaust purifying apparatus in the internal combustion engine in FIG. 1.

### DESCRIPTION OF EMBODIMENTS

Hereinafter, an explanation will be in detail made of preferred embodiments in the present invention. However, attention should be paid to that the embodiment in the present invention is not limited to each of the following embodiments, and the present invention includes all modifications and applications encompassed in the concept of the present invention defined in claims. Dimensions, materials, configurations, relative arrangements and the like of components described in the embodiments, unless particularly described, are not intended to limit a technical scope of the present invention to those only.

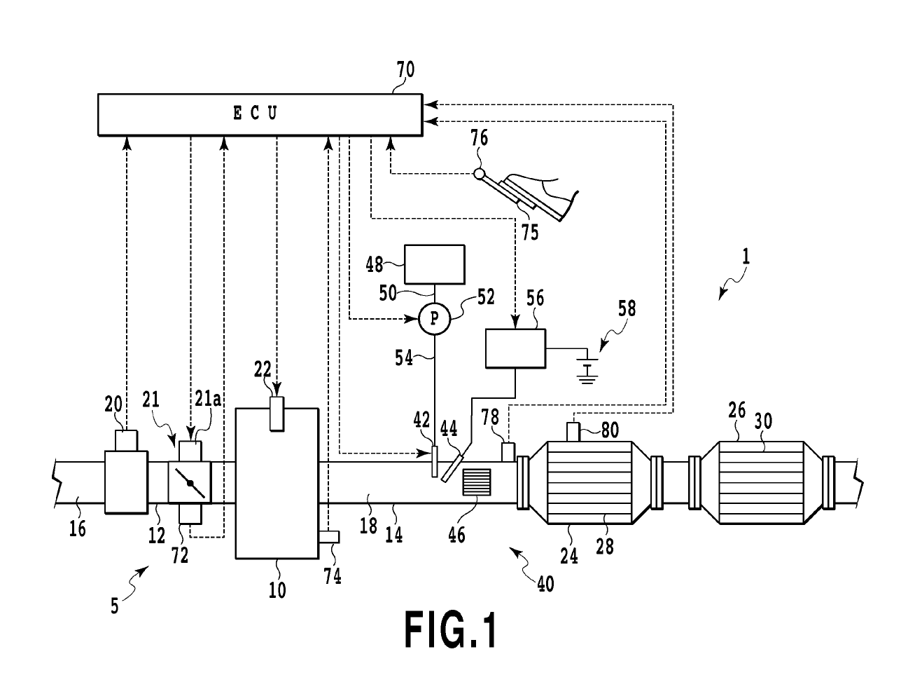

FIG. 1 shows a schematic configuration of an internal combustion engine (hereinafter, an engine) 5 provided with an exhaust purifying apparatus 1 in the internal combustion engine according to an embodiment. An engine body 10 forms part of an in-vehicle diesel engine of four cycles. An intake conduit 12 and an exhaust conduit 14 are connected to the engine body 10. The intake conduit 12 and the exhaust conduit 14 respectively define an intake passage 16 and an exhaust passage 18.

An air flow meter 20 is provided in the halfway of the intake conduit 12 for outputting a signal in accordance with a flow quantity of intake air flowing in the intake conduit 12. An intake air quantity (that is, intake flow quantity) per unit time flowing in the engine body 10 is detected based upon an output signal of the air flow meter 20. In addition, an electrically controlled intake throttle valve 21 is provided in the intake passage 16. However, the engine body 10 has in-line four cylinders and an in-cylinder fuel injection valve 22 is provided in each cylinder, but the single in-cylinder fuel injection valve 22 only is illustrated in FIG. 1.

A terminal of the exhaust conduit 14 is connected to a muffler (not shown) and is opened to an atmosphere at an outlet of the muffler. In addition, an exhaust purifying apparatus 1 is provided for purifying an exhaust gas in the exhaust passage 18.

The exhaust purifying apparatus 1 is provided with a plurality of exhaust treatment devices. A first catalyst converter 24 and a second catalyst converter 26 are arranged in an in-line manner in the halfway of the exhaust conduit 14 in order from the upstream side. In addition, a first exhaust treatment device (hereinafter, a first treatment device) 28 is accommodated in the first catalyst converter 24. The first treatment device 28 includes primarily an oxidation catalyst herein, and may be called simply an oxidation catalyst. In addition, a second exhaust treatment device (hereinafter, a second treatment device) 30 is accommodated in the second catalyst converter 26. The second treatment device 30 forms part of a particulate filter (DPF).

The first treatment device 28 including the oxidation catalyst makes unburned components of HC, CO and the like react to O₂ to form CO, CO₂, H₂O and the like. For example, Pt/CeO₂, Mn/CeO₂, Fe/CeO₂, Ni/CeO₂, Cu/CeO₂, or the like may be employed as a catalyst substance of the oxidation catalyst. The second treatment device 30 as the DPF traps particulates (PM, particulates) such as soot in the exhaust gas. Here, the second treatment device 30 as the DPF is configured as a successive regeneration system in which a catalyst made of a noble metal is carried and the trapped particulates can successively be oxidized and burned.

In addition to the first treatment device 28 and the second treatment device 30, a third exhaust treatment device (hereinafter, a third treatment device) including a NOx catalyst is preferably provided for purifying NOx (nitrogen oxides) in the exhaust gas. It should be noted that the third treatment device may be called simply a NOx catalyst. Preferably the NOx catalyst in the third treatment device is arranged downstream of the second treatment device 30. It should be noted that in a case of a spark ignition internal combustion engine (for example, a gasoline engine), an exhaust treatment device (hereinafter, a fourth treatment device), which can be called a three-way catalyst, is preferably provided in the exhaust passage. It should be noted that each of the first treatment device 28, the second treatment device 30, the third treatment device and the fourth treatment device corresponds to the exhaust treatment device in the present invention.

It should be noted that the third treatment device, that is, the NOx catalyst may be a NOx storage and reduction catalyst (NSR: NOx Storage Reduction). In this case, the NOx catalyst has a function that, when an oxygen density of an exhaust gas flowing therein is high, NOx in the exhaust gas is adsorbed, and when the oxygen density of the exhaust gas flowing therein is low and reduction components (for example, HC and the like) exist, the adsorption NOx is reduced. The NOx catalyst is configured such that a noble metal such as Platinum Pt as a catalyst component and NOx absorption components are carried on a surface of a substrate made of oxides such as Alumina Al₂O₃. The NOx absorption component consists of, for example, at least one selected from an alkali metal such as kalium K, natrium Na, lithium Li, or cesium Cs, an alkali earth such as barium Ba or calcium Ca, and a rare earth such as lantern La or yttrium Y. Alternatively, the NOx catalyst may be a Selective Catalytic Reduction NOx catalyst (SCR: Selective Catalytic Reduction). The Selective Catalytic Reduction NOx catalyst includes, for example, a NOx purifying catalyst for accelerating a chemical reaction (reduction reaction) between ammonia and NOx. In this case, for example, a urea water adding device for ammonia supply may be provided upstream of the NOx catalyst.

Further, the exhaust purifying apparatus 1 is provided with a temperature increasing device 40, and the temperature increasing device 40 is applied upstream of the first treatment device 28 in the exhaust passage 18. The temperature increasing device 40 includes a fuel adding valve 42 as a fuel adding means, a glow plug 44 as a heating means, and an oxidation device 46. It should be noted that the temperature increasing device 40 may be called a burner device since it can function as a burner as a whole, as described later.

The temperature increasing device 40 is arranged substantially downstream of the collecting portion in an exhaust manifold (not shown) connected to the engine body 10. A turbocharger may be provided downstream of the collecting portion in the exhaust manifold. In this case, the temperature increasing device 40 may be arranged downstream of the turbocharger and upstream of the first treatment device 28.

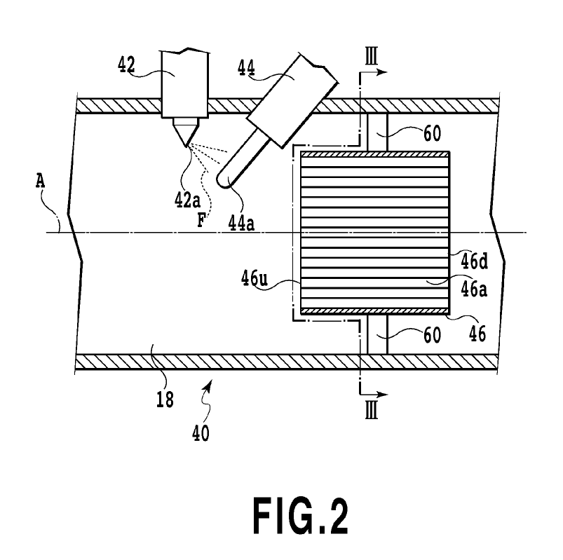

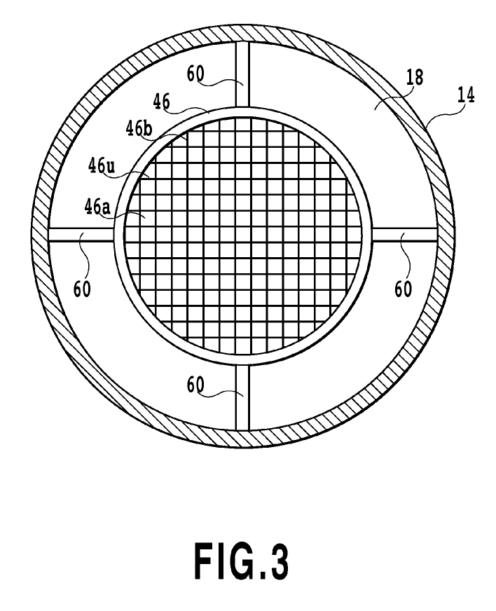

FIG. 2 and FIG. 3 show an enlarged schematic diagram in the periphery of the fuel adding valve 42, the glow plug 44, and the oxidation device 46 in the temperature increasing device 40.

As shown in the figures, the fuel adding valve 42 can add or inject liquid fuel F in the exhaust passage 18. Here, the fuel F employs light oil. The fuel adding valve 42 has a single injection hole 42a, but a plurality of injection holes may be formed. A fuel tank 48 of the engine 5 is connected through a fuel suction conduit 50 to a fuel pump 52. The fuel pump 52 herein is of a mechanical type, and operates utilizing a drive force of an unillustrated output shaft (crank shaft) of the engine 5. The fuel pump 52 is further connected through a fuel supply conduit 54 to the fuel adding valve 42. In the above-mentioned configuration, the fuel pump 52 sucks fuel reserved in the fuel tank 48 through the fuel suction conduit 50, and discharges the fuel to the fuel supply conduit 54, and thereby the fuel is supplied to the fuel adding valve 42.

The glow plug 44 is arranged such that a heat generating portion 44a as a tip end thereof is positioned in the exhaust passage downstream of the fuel adding valve 42 and upstream of the oxidation device 46. The glow plug 44 is connected through a pressure-increasing circuit 56 to an in-vehicle direct-current power source 58, and the heat generating portion 44a is heated at the time of being energized. The heat generated in the heat generating portion 44a enables fuel F added from the fuel adding valve 42 to be ignited and to generate flame. A part of the added fuel F can make direct contact with the heat generating portion 44a to be ignited. It should be noted that another device such as a ceramic heater, a spark plug or the like may be employed as the heating means, particularly an electrical heating device or a spark ignition device may be employed.

The oxidation device 46 is provided downstream of the glow plug 44 and upstream of the first treatment device 28 and is provided to oxidize or reform the fuel added from the fuel adding valve 42. The oxidation device 46 is herein configured to be provided with a carrier made of zeolite and an oxidation catalyst substance of rhodium or the like carried thereon. It should be noted that the oxidation device 46 is supported and fixed in the exhaust conduit 14 by means of support members 60.

As the fuel F is supplied to the oxidation device 46, when the oxidation device 46 is activated at this time, the fuel is oxidized in the oxidation device 46. Oxidation reaction heat generated at this time allows a temperature of the oxidation device 46 to be increased. Therefore the exhaust gas passing through the oxidation device 46 can be increased in temperature. In addition, as the temperature of the oxidation device 46 is increased, hydrocarbons having a large carbon number in the fuel are decomposed to generate hydrocarbons having a small carbon number and high reactivity. Thereby the fuel can be reformed to fuel having high reactivity. In other words, the oxidation device 46, on one hand, forms part of a rapid heat generator for rapidly generating heat, and on the other hand, part of a reform fuel discharger for discharging the reformed fuel.

As shown in FIG. 2, the fuel adding valve 42 injects fuel F in an obliquely downward direction toward the heat generating portion 44a of the glow plug 44 from above in such a manner as to go to the slightly downstream side. The injected fuel F has a predetermined spray angle, and generally forms a fuel pathway in a conical shape. The heat generating portion 44a is arranged in the halfway of the fuel pathway. The heating by means of the heat generating portion 44a in the glow plug 44 as the heating means enables the fuel added from the fuel adding valve 42 to be burned and the flame caused by the burning can reach the oxidation device 46.

In this manner, the temperature increasing device 40 can generate a high-temperature gas for heating, which in some cases contains flame. The gas for heating mixes with an exhaust gas supplied in the exhaust passage 18 from the engine body 10 to increase an exhaust temperature. The exhaust gas that is increased in temperature is supplied to the first treatment device 28 and the second treatment device 30 to accelerate the warming-up and activation thereof.

Incidentally the oxidation device 46 is provided with a plurality of gas passages 46a. The plurality of gas passages 46a are defined by wall portions 46b of the carrier in the oxidation device 46. It should be noted that the wall portions 46b defining the plurality of gas passages 46a are carried with the catalyst substance as described above, that is, coated with the catalyst substance. As shown in FIG. 2 and FIG. 3, each of the gas passages 46a is communicated with an upstream end surface 46u and a downstream end surface 46d in the oxidation device 46 respectively. In addition, the plurality of gas passages 46a are formed to be independent with each other. In other words, the oxidation device 46 in the present embodiment is formed of a so-called straight flow type having a plurality of independent cells extending approximately linearly from the upstream end to the downstream end, and the individual cell forms the gas passage 46a. It should be noted that, as apparent in FIG. 3, the exhaust conduit 14 is formed to have an approximately circular cross-section and the oxidation device 46 is formed to have an approximately circular cross-section, and the exhaust conduit 14 and the oxidation device 46 are arranged coaxially with each other.

On the other hand, the fuel that is added from the fuel adding valve 42 passes through the periphery of the heat generating portion 44a in the glow plug 44, reaches the oxidation device 46, and passes through the gas passage 46a in the oxidation device 46. As described above, the added fuel F can be burned before reaching the oxidation device 46, and flame generated by this burning can be fed to each of the gas passages 46a in the oxidation device 46.

The oxidation device 46 is designed and configured in consideration of the preferable passing of such flame or the gas containing such flame, and maintenance and securement of the exhaust purifying function. Here, an explanation will be in more detail made of the oxidation device 46.

The oxidation device 46 is formed to be provided with the gas passages 46a the number of which is equal to or more than 30 and is equal to or less than 200 per one square inch, that is, per 0.0006452 m² in a cross section on a plane substantially perpendicular to an exhaust flow passage direction A (refer to FIG. 2) (hereinafter, an exhaust flow passage direction cross-section). The number of the gas passages, that is, the cell number in the oxidation device 46 is, as described later, derived so as to realize both of the easy-to-pass degree of the flame and suppression of generation of the particulate such as soot.

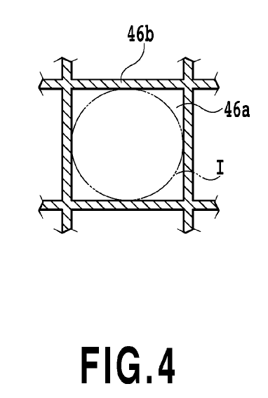

Here, one arbitrary gas passage 46a in the oxidation device 46 in the exhaust flow passage direction cross-section is shown in FIG. 4. In the present embodiment, since the cross-sectional configuration of the gas passage 46a has a substantially regular square, an inscribed circle I can be substantially defined therein. The oxidation device 46 in the present embodiment is designed such that the inscribed circle I in the gas passage 46a in the exhaust flow passage direction cross-section has a diameter which is equal to or more than 1.6 mm and is equal to or less than 4.9 mm.

Here, an explanation will be made of the number, the configuration, and the size of the gas passage as follows.

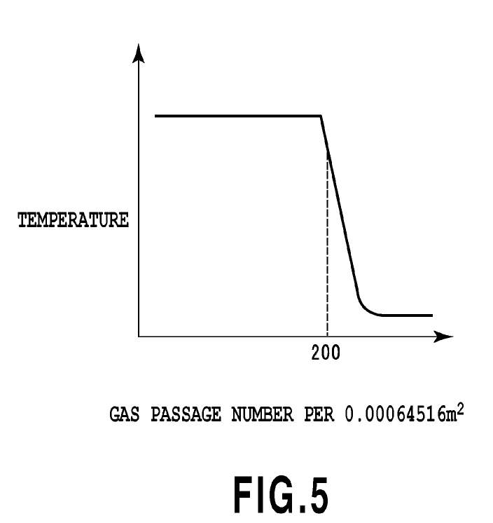

FIG. 5 is a graph conceptually depicting a relation between the number of the gas passages per 0.0006452 m² in the exhaust flow passage direction cross-section in the oxidation device and the passing characteristic value of a flame. A temperature downstream of the oxidation device at the time the flame has continuously been delivered to the oxidation device for a predetermined time is employed as the passing characteristic value of the flame. In the experiment the result of which is shown in FIG. 5, there are employed a plurality of oxidation devices which are different in the number of the gas passages per unit cross-sectional area in the exhaust flow passage direction cross-section, that is, the passage density (cell density). In the experiment, cpsi (cell per square inch) is employed as a unit of the passage density, and the plurality of oxidation devices are employed, each having the gas passage of 1 cpsi, 30 cpsi, 50 cpsi, 100 cpsi, 200 cpsi, 300 cpsi, or 400 cpsi in the exhaust flow passage direction cross-section. In addition, in the experiment, the flame was continuously delivered to each device for a predetermined time to examine to how many degrees the downstream temperature was increased. Specifically the temperature downstream of the oxidation device was measured based upon output of a temperature sensor provided downstream of the oxidation device to determine the passing degree of the flame in the oxidation device. In addition, when the temperature downstream of the oxidation device was a predetermined temperature (for example, 800° C.) corresponding to a flame temperature or more, it is determined that the flame passed through the oxidation device. However, the temperature downstream of the oxidation device corresponds to the maximum temperature that is obtained by means of the temperature sensor when the flame is continuously delivered to the oxidation device for a predetermined time.

As a result, when the number of the gas passages in the oxidation device, that is, the passage density is equal to or less than 200 cpsi, the result that the flame passes through the oxidation device is obtained.

In addition, by this experiment and the similar experiment, a relation between a cross-sectional configuration and a size of the gas passage in the oxidation device, and an easy-to-pass degree of the flame was examined. As a result, it was found out that the flame passed through the oxidation device when the gas passage in the oxidation device was formed such that a circle having a diameter of 1.6 mm or more made internal contact therewith in the exhaust flow passage direction cross-section.

From the above description, it was apparent that the preferable passing of the flame was secured when the number of the gas passages per unit cross-sectional area, that is, the passage density in the oxidation device was equal to or less than 200 cpsi (200 or less per 0.0006452 m²). In addition, for its realization, it was found out that it was preferable to form the gas passage in the oxidation device such that a circle having a diameter of 1.6 mm or more made internal contact therewith in the exhaust flow passage direction cross-section.

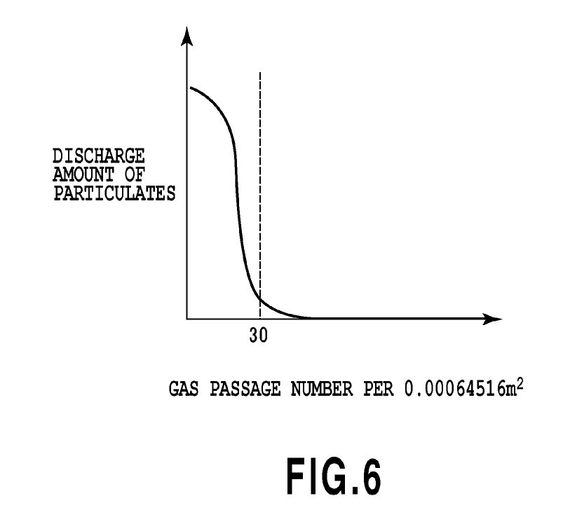

On the other hand, even in a case where the flame optimally passes through the oxidation device, it is not preferable that the exhaust state is deteriorated due to combustion of the fuel added by the fuel adding valve. Therefore a relation between the number of the gas passages in the oxidation device and the discharge amount of the particulates such as soot was examined by experiments. The result is conceptually depicted by a graph in FIG. 6. However, in the experiment, experimental passages having various sizes corresponding to the number of the gas passages per unit cross-sectional area in the oxidation device, and specifically experimental passages having sizes, each having a size corresponding to each of 1 cpsi, 15 cpsi, 30 cpsi, 50 cpsi, 100 cpsi, and 200 cpsi, were employed. In addition, in the experiment, the fuel was burned upstream of each experimental passage and the flame was delivered to each experimental passage. A sensor (soot detector) was arranged downstream of the experimental passage for detecting an amount of particulates in the gas, that is, a smoke amount, and the discharge amount of the particulates was evaluated based upon output of the sensor.

As a result, when the number of the gas passages in the oxidation device, that is, the passage density is 30 cpsi or more, it is found out that the discharge of the particulates can be suppressed to a predetermined amount or less. In this way, when the number of the gas passages in the oxidation device, that is, the passage density is made to 30 cpsi or more, the discharge amount of the particulates can be suppressed, and further, thereby pressure losses in the exhaust passage can be suppressed. In a case where the passage density, that is, the cell density is 1 cpsi, a region where the added fuel adheres is small in the oxidation device, and therefore vaporization of the fuel is difficult to be generated, and the discharge amount of the particulates is estimated to have exceeded the predetermined amount.

In addition, a relation between a cross-sectional configuration and a size of the gas passage in the oxidation device, and discharge of particulates was examined through this experiment and the similar experiment. As a result, when the gas passage in the oxidation device is formed such that a circle having a diameter of 4.9 mm or less makes internal contact therewith in the exhaust flow passage direction cross-section, it is found out that the discharge of the particulates can be suppressed.

From the above description, it is apparent that the discharge of the particulates can be optimally suppressed when the number of the gas passages per unit cross-sectional area in the oxidation device, that is, the passage density is equal to or more than 30 cpsi (30 or more per 0.0006452 m²). In addition, for its realization, it is found out that it is preferable to form the gas passage in the oxidation device such that a circle having a diameter of 4.9 mm or less makes internal contact therewith in the exhaust flow passage direction cross-section.

Based upon these experiments, as described above, the oxidation device 46 in the present embodiment is formed to be provided with the gas passages 46a the number of which is equal to or more than 30 and is equal to or less than 200 per 0.0006452 m² in the exhaust flow passage direction cross-section. In addition thereto, each of a large part of the gas passages 46a is formed such that a circle having a diameter which is equal to or more than 1.6 mm and is equal to or less than 4.9 mm makes internal contact therewith in the cross section.

However, application of the knowledge, which is obtained through the above experiments, that it is preferable that the gas passage in the oxidation device is formed such that a circle having a diameter which is equal to or more than 1.6 mm and is equal to or less than 4.9 mm makes internal contact therewith in the exhaust flow passage direction cross-section is not limited to a case where the inscribed circle is defined in the cross section of the gas passage. Here, this event will be in detail explained.

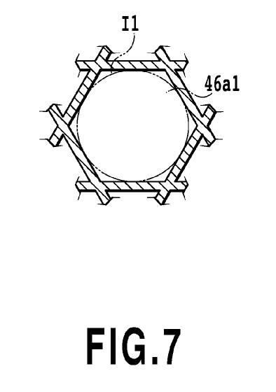

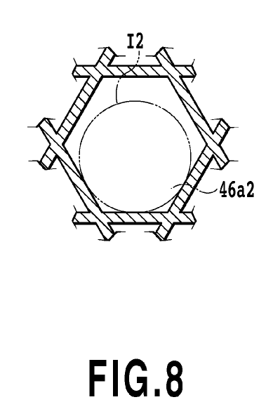

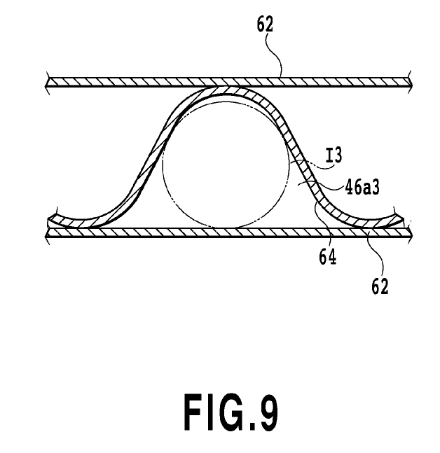

In the present embodiment, the configuration of the gas passage in the oxidation device in the exhaust flow passage direction cross-section is a substantially regular square as shown in FIG. 4, but the gas passage in the oxidation device can have another configuration or the like. For example, the configuration of the gas passage in the oxidation device in the exhaust flow passage direction cross-section may be a regular polygon such as a regular hexagon or a regular octagon. A gas passage 46a1 in an alternative oxidation device is depicted in FIG. 7, and the cross-sectional configuration is a substantially regular hexagon. In this case, an inscribed circle I1 can be defined in the gas passage 46a1 in the exhaust flow passage direction cross-section. In addition, the configuration of the gas passage in the oxidation device in the exhaust flow passage direction cross-section may not be a regular polygon, and, as described above, it is preferable to form the gas passage in the oxidation device such that a circle having a diameter which is equal to or more than 1.6 mm and is equal to or less than 4.9 mm makes internal contact therewith in the exhaust flow passage direction cross-section. For example, a gas passage 46a2 in a different, alternative oxidation device is depicted in FIG. 8, and the gas passage 46a2 is formed in a substantially regular hexagon such that a circle I2 makes internal contact with the gas passage 46a2 at three locations in the exhaust flow passage direction cross-section. In addition, a gas passage 46a3 in a further different, alternative oxidation device is depicted in FIG. 9, and a basic member, that is, a carrier of the oxidation device is formed by a combination of a flat plate member 62 and a wave-shaped member 64, wherein a clearance therebetween is defined as the gas passage 46a3. Also in this case, the gas passage 46a3 is formed such that a circle I3 makes internal contact with the gas passage 46a3 at three locations in the exhaust flow passage direction cross-section. It should be noted that it will be sufficiently understood by the person having ordinary skill in the art that the gas passage positioned in the edge portion in the oxidation device 46 may not be formed such that a circle having a diameter which is equal to or more than 1.6 mm and is equal to or less than 4.9 mm makes internal contact therewith in the exhaust flow passage direction cross-section. That is, preferably each of the majority of the gas passages in the oxidation device may be formed such that a circle having a diameter which is equal to or more than 1.6 mm and is equal to or less than 4.9 mm makes internal contact therewith in the exhaust flow passage direction cross-section.

Next, the present embodiment will be further explained. The engine 5 provided with the temperature increasing device 40 with the above-mentioned configuration is provided with an electronic control unit (hereinafter, called an ECU) 70 having functions as various kinds of control means. As shown in FIG. 1, the ECU 70 is provided together in the engine body 10 for controlling various devices according to an operating state of the engine body 10, a demand of a driver and the like. The ECU 70 is configured to include a CPU for executing various computing processing relating to engine control, a ROM for storing programs and data required for the control, a RAM for temporarily storing computing results of the CPU and the like, input/output ports for inputting/outputting signals between the ECU 70 and an outside, and the like.

Various sensors including the aforementioned air flow meter 20, and in addition thereto, a throttle opening degree sensor 72 for outputting an electrical signal in accordance with an opening degree (throttle opening degree) of the intake throttle valve 21, a crank angle sensor 74 for detecting a crank angle of the engine body 10, an accelerator opening degree sensor 76 for outputting an electrical signal in accordance with an opening degree (accelerator opening degree) of an accelerator pedal 75, a first temperature sensor 78 for detecting a temperature of an exhaust gas, and a temperature sensor 80 for detecting a temperature of the first treatment device 28 are connected through electrical wiring to the ECU 70. These output signals are inputted to the ECU 70. Therefore the ECU 70 can detect, for example, an intake air quantity based upon an output value of the air flow meter 20, detect an engine rotation speed based upon an output value of the crank angle sensor 74, and detect a required load of the engine body 10 based upon an output value of the accelerator opening degree sensor 76.

In addition, various devices including an actuator 21a of the throttle valve 21, the fuel injection valve 22, the fuel adding valve 42, and the glow plug 44 are connected through electrical wiring to the ECU 70. These operations are controlled by the ECU 70.

This ECU 70 has the control function of the entire engine 5, and has a function of a control means (control device) in the temperature increasing device 40. Specifically the ECU 70 includes a function of each of a fuel adding control means for controlling an operation of the fuel adding valve 42 as a fuel adding means, a heating control means for controlling an operation of the glow plug 44 as a heating means, and a pump control means for controlling an operation of the pump 52. Therefore the fuel adding device is configured to include the fuel adding valve 42 as the fuel adding means, and a part of the ECU 70, and the heating device is configured to include the glow plug 44 as the heating means, and a part of the ECU 70. In addition, the ECU 70 has a function of a determining means for determining a state of an exhaust gas downstream of the oxidation device 46, particularly a state of an exhaust gas downstream of the oxidation device 46 and upstream of the first exhaust treatment device 28, based upon output of the first temperature sensor 78 as a temperature detecting means provided in the exhaust passage downstream of the oxidation device 46. In addition, the ECU 70 includes a control function of an exhaust amount adjusting device for adjusting an exhaust amount supplied to the exhaust passage 18, and herein as shown hereinafter, the ECU 70 can control each operation of the fuel injection valve 22 and the throttle valve 21 in such a manner as to adjust the exhaust amount supplied to the exhaust passage 18.

In the engine 10, a fuel injection quantity and/or fuel injection timing are set based upon an engine operating state representative of an intake air quantity, an engine rotation speed, and the like, that is, an engine load and an engine rotation speed, for obtaining desired output. In addition, injection of fuel from the fuel injection valve 22 is performed based upon the fuel injection quantity and/or the fuel injection timing.

In addition, at the time of increasing a temperature of the exhaust treatment device, the ECU 70 controls the fuel adding valve 42 and the glow plug 44 to appropriately operate. That is, the ECU 70 appropriately drives to open (turns on) the fuel adding valve 42 to appropriately inject fuel from the fuel adding valve 42. Further, the ECU 70 appropriately energizes (turns on) the glow plug 44 to realize a sufficiently high temperature. Hereinafter, the control of the temperature increasing device 40 in the present embodiment will be explained.

In the temperature increasing device 40, the fuel adding valve 42 and the glow plug 44 are operated in such a manner that a temperature of the exhaust treatment device is increased to a predetermined temperature or more at the earlier time, particularly herein a temperature of the first treatment device 28 is increased to a predetermined active temperature region of the first treatment device 28 at the earlier time, for example, at the engine starting-up. That is, the glow plug 44 is energized and fuel is injected toward the tip end portion 44a from the fuel adding valve 42. A gas including this fuel or generated due to this fuel passes through the oxidation device 46 and the periphery thereof and reaches the exhaust treatment device. Such supply of the gas to the exhaust treatment device at the engine starting-up is performed from start of the engine starting-up, and continues to be performed until a temperature of the first treatment device 28 reaches a predetermined temperature within the predetermined active temperature region or more. It should be noted that herein the predetermined temperature within the predetermined active temperature region of the first treatment device is set to, for example, 200° C. However, preferably such supply of the heating gas to the exhaust treatment device at the engine starting-up continues to be performed until the engine warming-up is completed even if the temperature of the exhaust treatment device is increased at the earlier time. In this case, the completion of the engine warming-up is preferably determined based upon a cooling water temperature of the engine 10. For example, the temperature of the exhaust treatment device is increased at the earlier time, and thereafter the cooling water temperature of the engine 10 reaches a predetermined temperature (for example, 70° C.) or more, so that the ECU 70 determines that the engine warming-up is completed. At this time, the ECU 70 stops the operations of the fuel adding valve 42 and the operation of the glow plug 44 both.

Further, after the temperature of the first treatment device 28 reaches the above-mentioned predetermined active temperature region, the temperature increasing device 40 functions in such manner as to maintain the temperature of the first treatment device 28 to be within the predetermined active temperature region. Specifically when the temperature of the first treatment device 28 is in a lower limit temperature region (for example, temperature region of 200° C. or more and 250° C. or less) within the predetermined active temperature region, fuel is added from the fuel adding valve 42 and/or the glow plug 44 is energized (the glow plug is operated).

The temperature increasing device 40 operates for a predetermined time at a predetermined timing for removing PM trapped in the second treatment device 30 as the DPF, that is, for regenerating it. For example, each time a cumulative operating time of the engine 5 exceeds a predetermined time, the temperature increasing device 40 operates. It should be noted that the temperature increasing device 40 may operate when a difference in pressure across the second treatment device 30 reaches a predetermined pressure or more. In this case, preferably a pressure sensor for detecting a difference in pressure across the second treatment device 30, that is, a differential pressure sensor is provided.

The time of activating the fuel adding valve 42 and/or the glow plug 44 is the time of performing the heating in the exhaust passage to increase a temperature of the exhaust treatment device. However, such operations of the fuel adding valve 42 and/or the glow plug 44 cause oxidation or the like of fuel in the exhaust passage, and therefore, are preferably performed actively during the fuel cut or an idling operation. This is because the oxygen density in the exhaust passage is relatively high at such time.

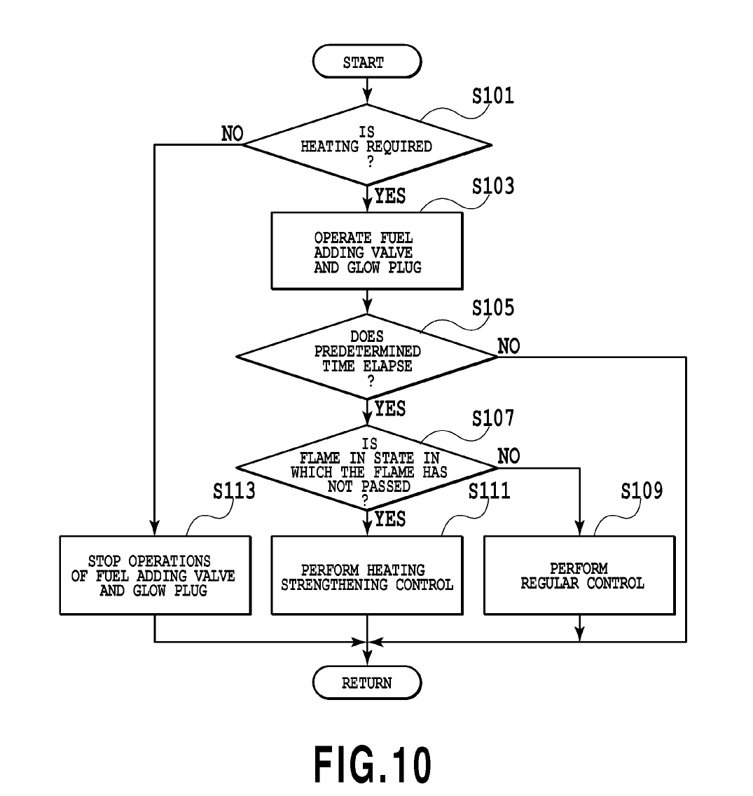

As described above, the ECU 70 determines whether or not the heating to the exhaust passage is required. When the ECU 70 determines that it is required, the ECU 70 controls the fuel adding valve 42 and/or the glow plug 44 to operate. In addition, each of such operations of the fuel adding valve 42 and the glow plug 44 is controlled according to a state of an exhaust gas downstream of the oxidation device 46 by the ECU 70. Hereinafter, the control thereof in the present embodiment will be explained with reference to a flow chart of FIG. 10.

First, the ECU 70 determines whether or not the heating is required (step S101). Whether or not the heating is required is determined based upon output from the aforementioned various sensors and/or the operating state. The case where the heating is required, as described above, includes the case of the engine starting, the case of performing a temperature increase of the exhaust treatment device and the case of performing regeneration of the second treatment device.

When it is determined that the heating is required (positive determination at step S101), the fuel adding valve 42 and the glow plug 44 are operated (step S103). This operation includes a case of operating the fuel adding valve 42 and the glow plug 44 both, and a case of operating only either one of the fuel adding valve 42 and the glow plug 44. Such selection of the operation mode is performed based upon the output from the aforementioned various sensors and/or the operating state, and based upon pre-stored data or the like. However, for simplification of explanation herein, only a case of operating the fuel adding valve 42 and the glow plug 44 both will be explained hereinafter. However, at the time the fuel adding valve 42 and the glow plug 44 have been in a stopped state so far, each of the fuel adding valve 42 and the glow plug 44 is operated according to basic data (for example, basic fuel adding quantity and basic supply power). In addition, at step S103 in the subsequent routine, the operating states of the fuel adding valve 42 and the glow plug 44 are maintained.

When the fuel adding valve 42 and the glow plug 44 are operated (step S103), it is determined whether or not a predetermined time elapses (step S105). Here, the time for the determination target is an elapse time from a point where it is determined that the heating is required, and is measured by the ECU 70. The predetermined time is in advance defined based upon experiments, and herein is a constant, but may be a variable number. It should be noted that the predetermined time may be defined based upon the experiment in FIG. 5 as described above.

When it is determined that the predetermined time has elapsed (positive determination at step S105), it is determined whether or not flame is in a state in which the flame has not passed through the oxidation device 46 (step S107). This determination (step S107) corresponds to determining a state of an exhaust gas downstream of the oxidation device 46. The ECU 70 determines whether or not the flame is in a state in which the flame has not passed based upon output from the first temperature sensor 78. Specifically this determination is made based upon whether or not a temperature detected based upon the output from the first temperature sensor 78 is less than a predetermined temperature (for example, less than 800° C.) corresponding to the flame having passed through the oxidation device 46.

When it is determined that the flame has passed through the oxidation device 46 (negative determination at step S107), the operations of the fuel adding valve 42 and the glow plug 44 continue to be performed as they are, according to the basic data or the data that has been corrected so far (step S109).

On the other hand, when it is determined that the flame has not passed through the oxidation device 46 (positive determination at step S107), the basic data is corrected in the operation control of the fuel adding valve 42 and the glow plug 44. In this case, since the flame does not pass through, for the purpose of strengthening the heating by increasing the heating amount more than before, the operation of the glow plug 44 is controlled to be corrected to increase supply power to the glow plug 44 and the operation of the fuel adding valve 42 is controlled to be corrected to increase the fuel adding quantity by the fuel adding valve 42 (step S111). It should be noted that at step S107 in the subsequent routine, the corrective amount is made larger. However, by either one of the increase of the supply power to the glow plug 44 and the increase of the fuel adding quantity by the fuel adding valve 42, it is possible to increase the heating amount more than before. Therefore only operation of either one of the fuel adding valve 42 and the glow plug 44 may be controlled to be corrected.

It should be noted that when it is determined that the flame does not pass through the oxidation device 46 (positive determination at step S107), it is also possible to perform feedback control at step S111. In this case, an operation of at least one of the fuel adding valve 42 and the glow plug 44 is feedback-controlled based upon the output from the first temperature sensor 78 in such a manner that the temperature downstream of the oxidation device 46 becomes close to a predetermined temperature (for example, 800° C.), for example.

It should be noted that when it is determined that the heating is not required (negative determination at step S101), the operations of the fuel adding valve 42 and the glow plug 44 are stopped (step S113).

In addition, in the present embodiment, when the heating is strengthened as described above (step S111), the ECU 70 adjusts the exhaust amount that is supplied to the exhaust passage 18. Specifically the exhaust amount is increased at this time. This indicates that the throttle valve 21 and the fuel injection valve 22 are controlled to be corrected such that the throttle opening degree is increased more than before and the fuel injection quantity is increased corresponding to the increased throttle opening degree. Thereby the amount of the exhaust gas flow is increased to accelerate vaporization of the fuel added from the fuel adding valve 42 and promote combustion of the added fuel. Accordingly it is possible to increase the temperature of the exhaust gas downstream of the oxidation device 46 more than before. It should be noted that in a case where the engine 5 is a spark ignition internal combustion engine, preferably the ignition timing also is controlled to be corrected. In addition, for the purpose of increasing the exhaust amount, preferably only either one of the respective operations of the throttle valve 21, the fuel injection valve 22, and the ignition plug may be controlled to be corrected. However, when the process goes to step S111, preferably only the exhaust amount that is supplied to the exhaust passage 18 may be adjusted as described above without performing the corrective control of the fuel adding valve 42 and the glow plug 44.

As described above, the present invention is explained based upon the embodiment and the modification, but the present invention is not limited thereto, and allows other embodiments. For example, in the above-mentioned embodiment, the fuel adding valve is employed as the fuel adding means, wherein the same fuel as the fuel of the engine is added from the fuel adding valve. However, other fuel may be employed, and for example, alcohol such as ethanol, methanol or the like may be employed as an additive agent.

In addition, the number, the kind, the configuration, and arrangement order of the exhaust treatment devices that are provided in the exhaust passage are not limited to those in the above-mentioned embodiment. The number of the exhaust treatment device may be one, two, four or more than that. Various kinds of catalysts, filters and the like may be employed as the exhaust treatment device. In addition, the above-mentioned oxidation device may not include the oxidation catalyst having the above-mentioned configuration, and may include a catalyst with a different oxidation function. The oxidation catalyst in the first treatment device 28 may be the same as or different from the oxidation catalyst in the oxidation device 46.

In the above-mentioned embodiment, the first temperature sensor as the temperature detecting means is employed for determining the state of the exhaust gas downstream of the oxidation device, but the other detecting means may be employed. For example, a sensor output of which changes according to an exhaust component, such as an A/F sensor, an O₂ sensor or a NOx sensor, may be employed as the detecting means. Part of the ECU functioning as the determining means based upon the output of the above means can determine the state of the exhaust gas downstream of the oxidation device. In this case, the ECU can control the operation of both or one of the fuel adding valve and the glow plug according to the determined state of the exhaust gas downstream of the oxidation device.

In addition, in the above-mentioned embodiment, the present invention is applied to the diesel engine, but is not limited thereto, and the present invention may be applied to various types of engines such as a port injection gasoline engine or an in-cylinder injection gasoline engine. In addition, fuel in use is not limited to light oil or gasoline, and may be alcohol fuel, LPG (liquid natural gas) or the like. In addition, the cylinder number, the cylinder arrangement type or the like of the engine to which the present invention is applied may employ any one.

As described above, the present invention is explained with some degree of concreteness, but it should be understood that various changes and modifications can be made without departing from the spirit and the scope of the invention defined in claims. The embodiment in the present invention is not limited to the aforementioned embodiments, but the present invention includes all modifications and applications encompassed in the concept in the present invention defined in claims. Therefore the present invention should not be interpreted in a limiting manner and can be applied to any other technology within the scope in the concept in the present invention. The means for solving the problem in the present invention may be employed to be combined as much as possible.

1. An exhaust purifying apparatus in an internal combustion engine provided with an exhaust treatment device in an exhaust passage, comprising:
a temperature increasing device including:
an oxidation device provided upstream of the exhaust treatment device;
a fuel adding unit configured to add fuel upstream of the oxidation device; and
a heating unit, provided upstream of the oxidation device, configured to heat the fuel added from the fuel adding unit, wherein
the oxidation device is formed to be provided with gas passages the number of which is equal to or more than 30 and is equal to or less than 200 per 0.00064516 m² in an exhaust flow passage direction cross-section such that flame generated by the heating unit heating fuel added by the fuel adding unit passes through the oxidation device and such that the discharge of the particulates from the temperature increasing device is suppressed.

2. An exhaust purifying apparatus in an internal combustion engine according to claim 1, wherein
each of the gas passages in the oxidation device is formed such that a circle having a diameter which is equal to or more than 1.6 mm and is equal to or less than 4.9 mm makes internal contact therewith in the exhaust flow passage direction cross-section.

3. An exhaust purifying apparatus in an internal combustion engine according to claim 1, further comprising:
a detecting unit output of which changes with a state of an exhaust gas downstream of the oxidation device; and
a determining unit configured to determine the state of the exhaust gas downstream of the oxidation device based upon the output of the detecting unit.

4. An exhaust purifying apparatus in an internal combustion engine according to claim 3, wherein
a control unit configured to control an operation of at least one of the fuel adding unit and the heating unit controls the operation of at least one of the fuel adding unit and the heating unit according to the state of the exhaust gas downstream of the oxidation device determined by the determining unit.

5. An exhaust purifying apparatus in an internal combustion engine according to claim 1, further comprising:
a temperature detecting unit provided in the exhaust passage downstream of the oxidation device; and
a determining unit configured to determine whether or not a temperature downstream of the oxidation device is less than a predetermined temperature corresponding to the passing of flame through the oxidation device, based upon output of the temperature detecting unit.

6. An exhaust purifying apparatus in an internal combustion engine according to claim 5, wherein
a control unit configured to control an operation of at least one of the fuel adding unit and the heating unit controls the operation of at least one of the fuel adding unit and the heating unit in such a manner as to increase the heating amount more than before when it is determined that the temperature downstream of the oxidation device is less than the predetermined temperature by the determining unit.

7. An exhaust purifying apparatus in an internal combustion engine according to claim 5, further comprising:
an exhaust amount adjusting device for adjusting an exhaust amount that is supplied to the exhaust passage, wherein
the exhaust amount adjusting device, when it is determined that the temperature downstream of the oxidation device is less than the predetermined temperature by the determining unit, increases the exhaust amount more than before.
